(19) United States
(12) Patent Application Publication
(10) Pub. No.: US 2013/0209745 A1
(43) Pub. Date: Aug. 15, 2013

(54) METHOD OF COATING OF A SUBSTRATE WITH A THERMAL SPRAY COATING MATERIAL AND COATED SUBSTRATE FORMED THEREBY

(71) Applicants: Jean-Gabriel LEGOUX, Repentigny (CA); Athinodoros Chris Kazanas, Laval (CA); Jean-Michel LAMARRE, Montreal (CA); Pierre MARCOUX, Beloeil (CA)

(72) Inventors: Jean-Gabriel LEGOUX, Repentigny (CA); Athinodoros Chris Kazanas, Laval (CA); Jean-Michel LAMARRE, Montreal (CA); Pierre MARCOUX, Beloeil (CA)

(73) Assignee: NATIONAL RESEARCH COUNCIL OF CANADA, Ottawa (CA)

(21) Appl. No.: 13/370,838

(22) Filed: Feb. 10, 2012

(51) Int. Cl. B32B 3/30; B05D 1/12

(52) U.S. Cl. 428/161; 427/448

(57) ABSTRACT

A method of coating a surface of a substrate with a particulate coating material, the method comprising: determining at least an area of the surface of the substrate to be covered with the particulate coating material; subjecting at least a portion of the area of the surface of the substrate to laser irradiation to form a plurality of distinct spaced-apart laser impact craters in a pattern and/or at least one last impact pit on the surface of the substrate; and thermally spraying the area of the surface of the substrate with the particulate coating material. A coated substrate comprising: a substrate having a plurality of distinct spaced-apart laser impact craters in a pattern and/or at least one laser impact pit on at least an area of a surface of the substrate; a thermally-sprayed coating mechanically bonded to at least the area of the surface of the substrate.

### FIELD

The present invention generally relates to methods of coating a surface of a substrate with a particulate coating material, and coated substrates formed by such methods.

### BACKGROUND

Thermal spray is a process for the deposition of coatings that can be used for the modification of a wide variety of surfaces (e.g., metals and ceramics) of various substrates (e.g. metals, ceramics, polymers, etc.) Molten or semi-molten particles are produced using an energy source (e.g. electric arc, plasma, flame) and a feedstock (e.g. wire, powder) and projected at high speeds onto a substrate. Upon impact, the particles deform, cool, solidify and stick on to the substrate forming lamellar structures named splats. It is generally accepted that the coating main adhesion mechanism is mechanical bonding between the splats and the substrate.

Cold spray, or kinetic spray, can be considered a subset of thermal spray processes. Cold spray is a material coating method in which solid-state powders (typically 1 to 50 micrometers in diameter) are accelerated in supersonic gas jets to velocities up to 500-1000 m/s. During impact with the substrate, particles undergo plastic deformation and bond to the surface. Metals, polymers, and composite materials can be deposited using cold spray.

In order for a thermal spray coating to adhere properly to a substrate, the surface morphology of the substrate surface needs to satisfy certain criteria so that the mechanical bonding is sufficient for a given application. Mechanical adhesion is a function of the deposited material, the spray parameters, the substrate composition and the process parameters used to prepare the substrate surface prior to deposition.

Thermal spray substrates are generally prepared using two processes: cleaning and roughening. The aims of the cleaning step can be for example: to remove impurities (e.g. oil, grease or other organic compounds, metallic dust, etc.) and/or to chemically modify (de-oxidizing or oxidizing) the surface. The roughening step is used to modify the substrate morphology in such a way as to create anchoring points for the incoming particles.

The most commonly used technique for roughening a substrate prior to deposition is grit blasting, which consists of eroding and deforming the substrate surface using grit particles. Grit blasting enhances the roughness and also helps to remove oxide layers present on metallic surfaces. However, this technique suffers from several shortcomings:
Grit blasting involves using grit (e.g. Al₂O₃, SiC, SiO₂) creating a significant amount of dust resulting in a soiled or contaminated working environment.
The used grit particles represent a large amount of waste in the context of mass volume production.
Grit residues (impurities and/or inclusions) are left on the substrate surface, which reduces adhesion. Another step of substrate cleaning using compressed air, for example, is standard good practice and is usually required after the grit blasting to remove impurities that could affect the properties of the coated surface.
The morphology of the roughened substrate such as the depth and pattern of the roughening are difficult to control.
Grit blasting induces compressive residual stress, which in the case of thin substrates, can deform the substrate and impact its integrity and functionality.
The use of a tedious masking procedure is required if one needs to protect areas of the substrates from grit blasting (no coating areas, no blast permitted areas or overblast protection). This can happen for example if only a fraction of the substrate needs to be coated or if the backside of the substrate needs not or should not be grit blasted.

Other known techniques for surface roughening include the use of chemical reactants to create etched surfaces, but these also leads to significant waste products and are also difficult to control.

Lasers have been used to clean and deoxidize a surface prior to applying a thermal spray coating. The laser configuration and processes existing for cleaning the surface does not result in a morphology modification comparable to grit blasting. The resulting changes in morphology do not lead to a substantial roughness increase (surface features are shallower than 1 m).

Given the available techniques, there is a need for a method to deposit thermal spray coatings with good adhesion strength on various substrates while reducing environmental waste and simplifying the manufacturing process by having a controllable, repeatable and robust process.

### SUMMARY

In one aspect, there is provided a method of coating a surface of a substrate with a thermal spray coating material, the method comprising: determining an area of the surface of the substrate to be covered with the particulate coating material; subjecting at least a portion of the area of the surface of the substrate to laser irradiation to form a plurality of distinct spaced-apart laser impact craters in a pattern on the surface of the substrate; and thermally spraying the area of the surface of the substrate with the thermal spray coating material.

In some embodiments, the surface of the substrate defines a baseline, and wherein each of the distinct laser impact craters has a floor, the floor being below the baseline. In some such embodiments, each of the distinct laser impact craters has a rim, the rim being above the baseline. In some such embodiments, particles of the particulate coating material have a pre-determined pre-impact average diameter; and wherein each of the distinct laser impact craters has a width, the widths being within a range of 50% to 150% of the average particle diameter. In some such embodiments, rims of adjacent distinct laser impact craters are spaced apart by an inter-rim distance, the inter-rim distances being within a predetermined range of the pre-impact average particle diameter. In some such embodiments, each of the distinct laser impact craters has a depth, the depths being within a predetermined range of the pre-impact average particle diameter. In such embodiments, the pattern is random.

In some embodiments, the pattern is a fixed repeating pattern of aligned rows of laser impact craters forming an aligned array.

In some embodiments, the pattern is a fixed repeating patterns of offset rows of laser impact craters forming a staggered array.

In another aspect, there is provided a method of coating a surface of a substrate with a thermal spray coating material, the method comprising: determining an area of the surface of the substrate to be covered with the coating material; subjecting at least a portion of the area of the surface of the substrate to laser irradiation to form at least one laser impact pit on the surface of the substrate; and thermally spraying the area of the surface of the substrate with the thermal spray coating material.

In some embodiments, the at least one laser impact pit is a plurality of distinct laser impact pits. In some such embodiments, the surface of the substrate defines a baseline, and wherein each of the plurality of distinct laser impact pit has a floor, the floor being below the baseline. In some such embodiments, each of the distinct laser impact pit has a rim, the rim being above the baseline. In some such embodiments, particles of the thermal spray coating material have an pre-impact average particle diameter; and each of the plurality of distinct laser impact pit has a width, the widths being within a predetermined range of the average pre-impact particle diameter. In some such embodiments, rims of adjacent distinct laser impact pits are spaced apart by an inter-rim distance, the inter-rim distances being within a predetermined range of the average pre-impact particle diameter. In some such embodiments, each of the distinct laser impact pits has a depth, the depths being within a predetermined range of the average pre-impact particle diameter. In some such embodiments, the plurality of distinct laser impact pits form a crisscross pattern.

In another aspect, there is provided a coated substrate comprising: a substrate having a plurality of distinct spaced-apart laser impact craters in a pattern on an area of a surface of the substrate; a thermally-sprayed coating mechanically bonded to at least the area of the surface of the substrate.

In some embodiments, the surface of the substrate defines a baseline, and each of the distinct laser impact craters has a floor, the floor being below the baseline. In some such embodiments, each of the distinct laser impact craters has a rim, the rim being above the baseline. In some such embodiments, each of the distinct laser impact craters has a width and a depth; and rims of adjacent distinct laser impact craters are spaced apart by an inter-rim distance; and the crater widths, crater depths, and inter-rim distances are all within a predetermined range of one another.

In some embodiments, the pattern is random.

In some embodiments, the pattern is a fixed repeating pattern of aligned rows of laser impact craters forming an aligned array.

In some embodiments, the pattern is a fixed repeating pattern of offset rows of laser impact craters forming a staggered array.

In another aspect there is provided a coated substrate comprising: a substrate having at least one laser impact pit on an area of a surface of the substrate; a thermally-sprayed coating mechanically bonded to at least the area of the surface of the substrate.

In some embodiments, the at least one laser impact pit is a plurality of distinct laser impact pits. In some such embodiments, the surface of the substrate defines a baseline, and each of the plurality of distinct laser impact pits has a floor, the floor of each pit being below the baseline. In some such embodiments, each of the distinct laser impact pits has a width and a depth; and rims of adjacent distinct laser impact pits are spaced apart by an inter-rim distance; and the pit widths, pit depths, and inter-rim distances are all within a predetermined range of one another. In some such embodiments, the plurality of distinct laser impact pits form a crisscross pattern.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### ADVANTAGES COMPARED TO CURRENT TECHNOLOGIES

The surface preparation process disclosed herein compares favorably to existing gritblasting technology. Using a laser to roughen surface eliminates the need for grit, considerably reducing environmental waste management issues, dust problems and possible surface contamination by foreign chemical species. Another problem with grit blasting is cross contamination of substrates by embedded dissimilar metallic particles. These metallic particles consist of eroded particles coming from a previous grit blasting operation on a different material. These particles end up in the grit hopper among grit particles. When a second material is blasted using the same grit hopper, it can be contaminated with traces of the first material. Examples of such dissimilar materials are Ti, Al or steel.

Moreover, the introduction of the laser improves flexibility and control on the roughening process. The laser parameters can be adjusted in such a way as to control the shape and morphology of the roughened substrate. For example, different surface characteristics can be achieved by adjusting relevant parameters:
Crater depth: laser power, number of pulses (pulsed laser) per feature, time at each feature (continuous wave laser), and wavelength (to take into account different substrates absorption properties).
Crater size: laser spot size (constant power density).
Inter-crater distance: change the sweeping parameters of the laser.

Another advantage of the laser process resides in the low thermal and mechanical loads applied to the treated part. This results in low residual stresses and low deformations which are beneficial for thin substrates.

The possibility to control the laser path together with the high directionality of the laser beam renders masking unnecessary. Furthermore, a minimal size of the area, much smaller with a laser process, can be roughened, allowing for easy treatment of small or high precision parts.

### BRIEF DESCRIPTION OF THE DRAWINGS

For a better understanding of the present invention, as well as other aspects and further features thereof, reference is made to the following description which is to be used in conjunction with the accompanying drawings, in which:

FIG. 1 is a confocal microscopy picture of a mild steel substrate surface morphology prepared using a standard 24 Mesh gritblasting procedure used in prior art.

FIG. 2 is a confocal microscopy picture of a mild steel substrate surface morphology modified by laser.

FIG. 3 is a schematic diagram illustrating different patterns for modifying the morphology of the surface of the substrate.

FIG. 4 is a scanning electron microscopy picture of a mild steel substrate surface morphology modified by laser.

FIG. 5 is a schematic representation of different roughness scenarios for incoming particle adhesion.

FIG. 6 is a schematic representation of the monitoring system for the laser roughening procedure.

### DETAILED DESCRIPTION

Throughout this description, the term substrate should be understood to comprise a bare substrate or an already coated substrate.

The term thermal spray coating includes any material deposited by a thermal spray, kinetic spray or cold spray process among for example, but not restricted to, cold spray, arc wire spray, plasma spray and HVOF.

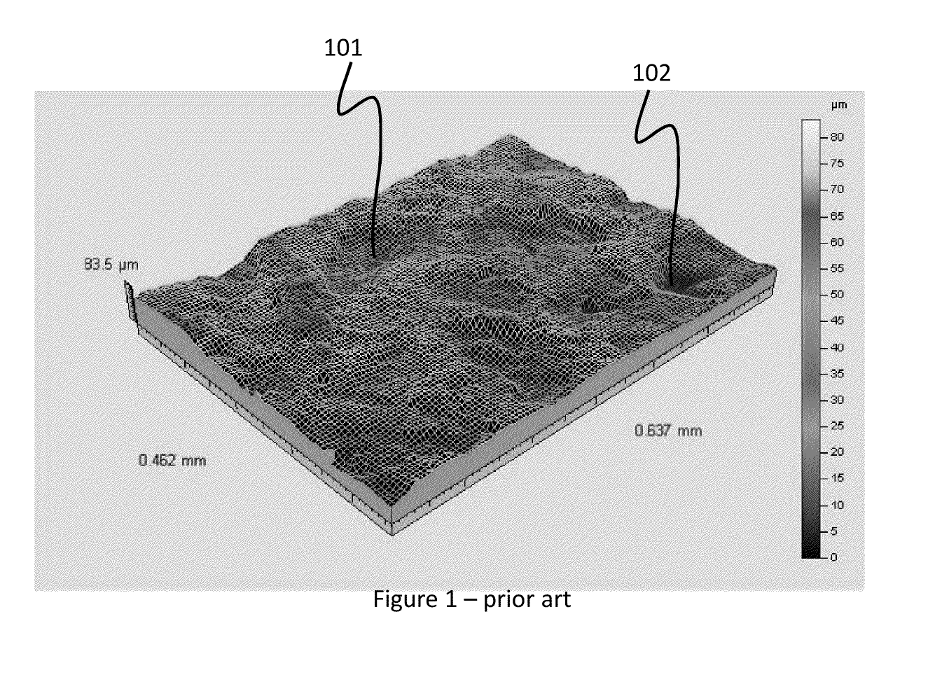

FIG. 1 depicts a surface that was created using a 24-mesh grit blasting process. Using grit blasting, indentations are made by impacting grit particles through their deformation and cutting actions. The location and depth of the pits (101 and 102) is random and control is difficult. In this example, one pit 102 is significantly deeper than another 101. With grit blasting, it is difficult to tailor the adhesion characteristics. Adhesion strength is subject to the random nature of the process and is thus prone to local non-uniformities.

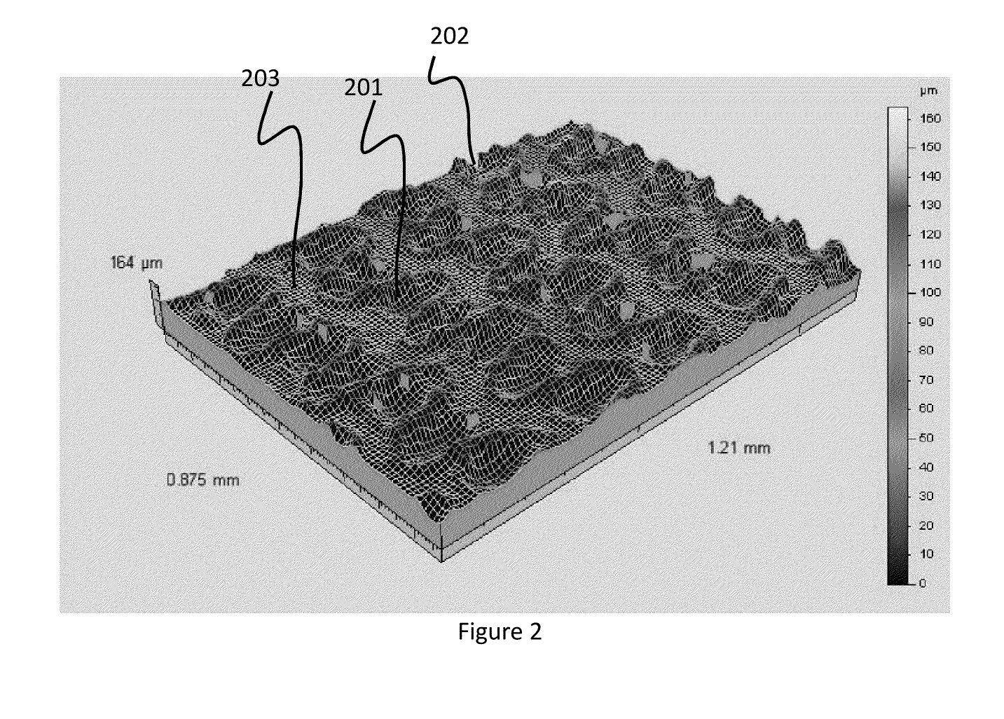

To control adhesion and reduce waste, a laser can be used to modify the surface of substrates in order to promote adhesion of thermal spray coatings. The laser is used to produce features similar to pits on the surface of a substrate using non-perforating cuts. The features are referred to in the description as “craters”. The craters are formed in the substrate by a local change of morphology resulting of the interaction of a focused laser beam and the material surface. FIG. 2 depicts an embodiment showing the change in morphology resulting from the laser pulses as compared to the baseline substrate 203. The baseline of the substrate being the substrate surface prior to the laser process treatment. The laser action creates a crater or negative feature 201 in comparison to the baseline 203 and a zone of molten/re-solidified material, which may or may not represent a positive feature 202 as compared to the baseline 203. The depth of all the craters 201 is uniform. In this case the craters are organized in rows 202 and are equally spaced. The adhesion characteristics will be uniform across the prepared surface.

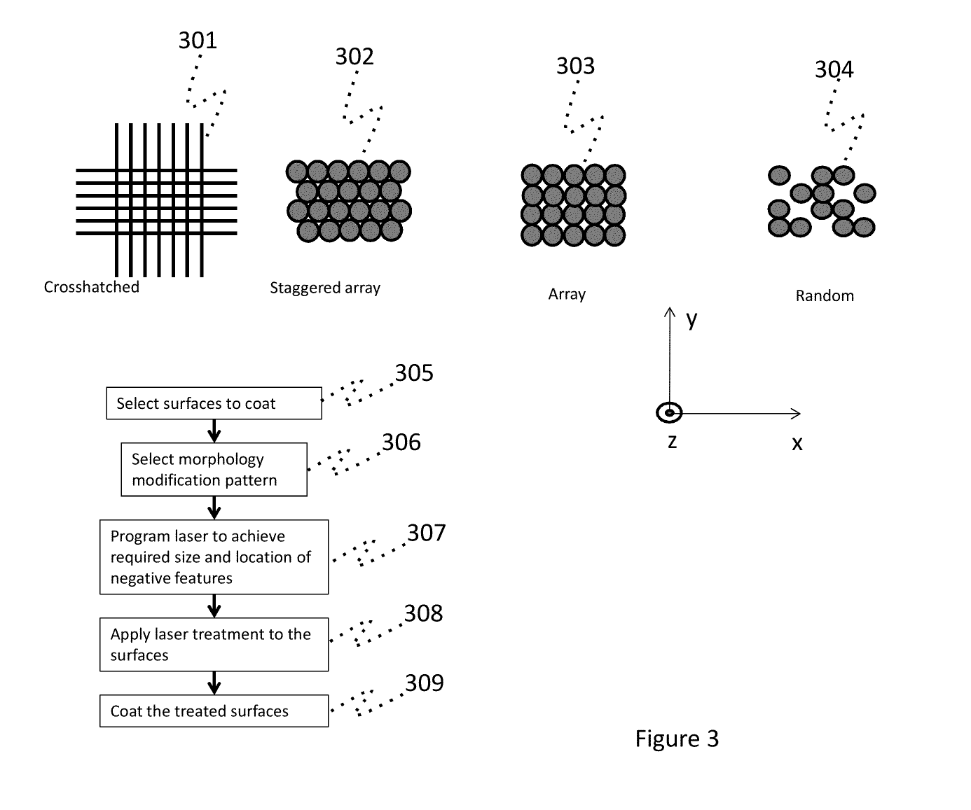

The pattern of the craters can be predetermined or random as shown in different embodiments in FIG. 3. In these examples, the craters are organized, in crosshatched lines and columns 301, staggered array of spots 302, simple array 303 or randomized 304 or a combination of the above. The crosshatched lines and the simple array can be programmed and executed faster. The staggered array 302 generally provides the strongest bond strength. Different positioning of the craters can be used to result in different adhesion properties (e.g. anisotropic adhesion and stress properties).

Referring to FIG. 3, the surfaces that require coating are selected 305. The pattern for the morphology modification is selected 306 and the laser parameters are programmed 307 to achieve the expected adhesion properties. The laser action is then applied to each selected surfaces 308, prior to applying the coating 309.

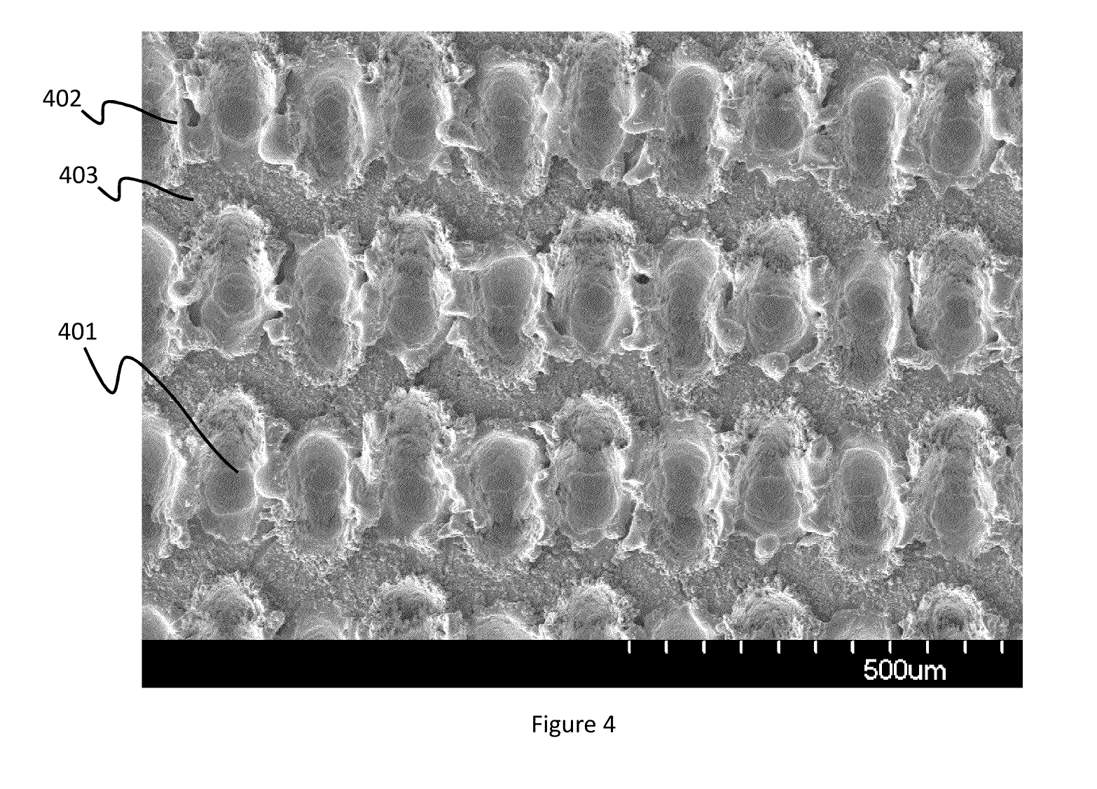

FIG. 4 depicts a scanning electron microscopy picture of the surface shown in FIG. 2. In this embodiment, the width of the craters 401 is roughly 75 m and the craters are organized in rows and columns to form an array of craters 303. The positive features 402 and the baseline 403 are also shown on the picture.

The laser can be a pulsed laser or a continuous wave laser with or without a shadowing device to create discrete craters. In the case of a pulsed laser, craters can be created using single pulse or multiple pulses. In the case of a continuous laser, features are created by stopping the motion of the laser at given positions for a certain amount of time.

A continuous wave laser can be used to create a roughening pattern consisting of a series of lines (per FIG. 3). A line pattern can also be formed using a pulsed laser by overlapping features.

### Morphology Modification

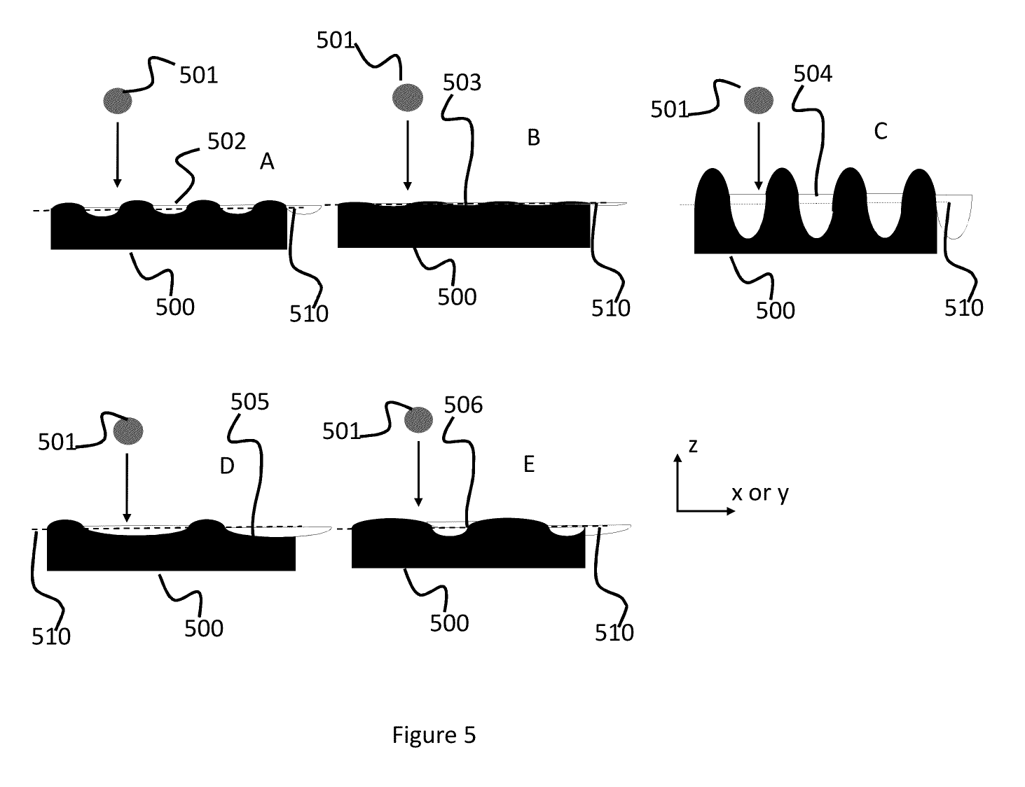

To control adhesion, it is generally necessary to create sufficient roughness in the z-direction (see FIG. 5). The depth of the craters needs to be much greater than 1 m to provide sufficient adhesion for most substrate/material couples.

It is also generally necessary to ensure that the x-y distance (see FIG. 5) between the features is small in order to obtain good area coverage. Splats do not adhere well to untreated surfaces.

Furthermore, the features' size (x-y plane) needs to be adjusted depending on the splats size. As a general rule, craters should be large enough compared to the splat size as to provide sufficient anchoring for the incoming particles, but small enough to lower the odds of having incoming particle depositing in a relatively flat area, usually situated in the vicinity of the middle of the craters.

FIG. 5 is a schematic representation of different roughness scenarios for incoming particle 501 adhesion to a surface 500 of a given baseline 510. In example A, the craters 502 are properly sized in the z and x direction. In example B, the craters 503 are too small in the z-direction. In example C, the craters 504 are too large in the z-direction. In example D, the craters 505 size is too large. In example E, the distance between craters 506 is too large.

In the case where the pattern of features is dense enough to minimize the amount of untreated surface, an added benefit is to eliminate the need for cleaning and/or deoxidizing.

### Cleaning

Cleaning includes the operation of removing oil, grease or other organic compounds along with fine foreign particles. The cleaning process can be done using the same laser used for the morphology modification but with different parameters, in this case, the laser is used to burn the impurities, but not to modify the morphology, surface features or structure of the substrate.

Chemical solvents or soaps can also be used for the cleaning process, although this creates waste materials.

### Chemical Modification

If required, the modified surface can be treated to remove oxidation prior to the coating procedure. In some cases, the laser can be used to oxidize the surface or to passivate it. Deoxidizing can be done using a laser at the same time as the cleaning process. Acid or chemical treatments can also be used to change the chemical property of the modified substrate. If the laser morphology modification is done under a gas shroud or atmosphere, there may not be a need to de-oxidize the surface.

### Process Monitoring

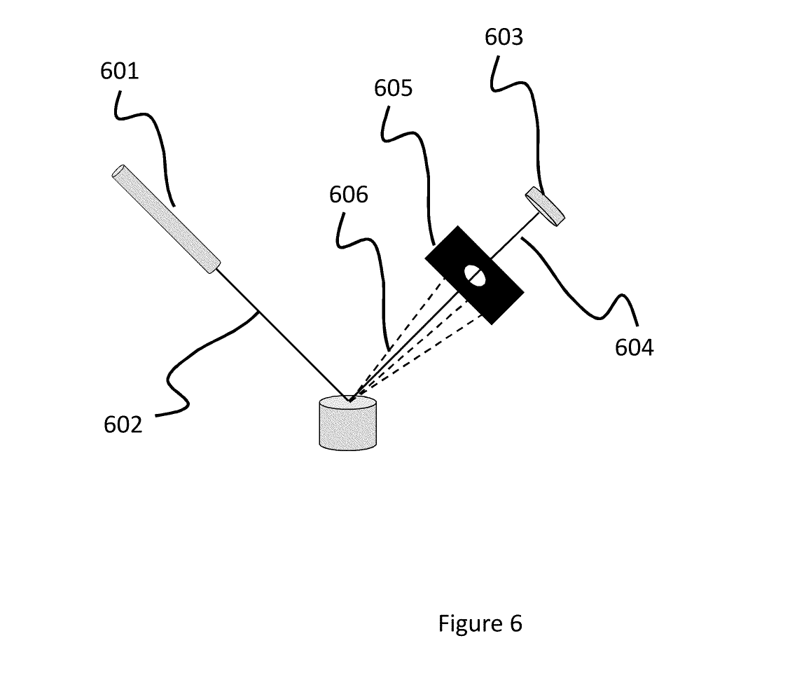

The reflection coefficient of a metallic surface strongly depends on the surface finish and/or roughness. A rough surface absorbs and/or scatters more light than a polished one. Thus, the roughness level of a metallic substrate can be monitored in-situ by measuring the specular reflection coefficient of the surface. This measurement can be performed using the process laser or a second dedicated laser. An example setup using the process laser 601 is shown in FIG. 6. This process would involve:
1) Defocusing the laser beam 602 as to reduce the laser beam intensity to prevent further surface modification. Defocusing the beam also allows for a larger probed area.
2) Use an aperture 605 on the detector side in order to prevent scattered light 606 to reach the detector 603. The reflected signal 604 is measured by the detector 603.

### Performance Comparison

For comparison purposes, three samples were prepared with the following experimental conditions:

1) Substrate: mild steel
Roughening technique: Gritblast
Grit: 24 Mesh
Deposition: plasma sprayed alumina.

2) Substrate: mild steel
Roughening technique: Gritblast
Grit: 60 Mesh,
Deposition: plasma sprayed alumina.

3) Substrate: mild steel
Roughening technique: laser
Deposition: plasma sprayed alumina.

Samples 1 and 2 were prepared according to a standard gritblasting procedure using two different grit sizes (24 and 60 Mesh). The process parameters used for the grit blasting experiments are given in table 1.

TABLE 1
Grit Blasting Test Parameters

| Grit blasting parameters | Value |
|---|---|
| Grit Material | Al₂O₃ |
| Size | 24 and 60 Mesh |
| Angle | 45-60° |
| Distance | 10-20 cm |
| Time | 100% of coverage |
| Operation pressure | 40-55 psi |
| Nozzle size | 0.95 cm |

Sample 3 was prepared according to the procedure described in this disclosure. The parameters used for the laser roughening experiment are given in table 2.

TABLE 2
Laser Roughening Test Parameters

| Laser parameter | Value | |
|---|---|---|
| Wavelength | 1070 | nm |
| Power | 30 | W |
| Pulse length | 50 | ns |
| Repetition rate | 50 | kHz |

| | |
|---|---|
| Spot size (width) | ≈120-140 m |
| Traveling speed | 2.5 inch per second |

The resulting substrate morphologies were characterized before plasma deposition using confocal microscopy and scanning electron microscopy and are shown in FIGS. 2 to 4.

Roughness values were measured using a mechanical surface roughness tester and confocal microscopy. Surface roughness values can be determined using equation (1).

$${S}_{a} = \frac{1}{mn} {\sum }_{i = 1}^{n} {\sum }_{j = 1}^{m} \vert {z}_{ij} - \overline{z} \vert \qquad ( 1 )$$

where m and n represent respectively the number of data in the x and y direction of the measurement array, z is the measured height and z-bar represent the average of the measured heights.

Adhesion tests were performed according to ASTM-C633. A summary of the obtained results is presented in table 3.

TABLE 3
Adhesion and Roughness Results

| | Techniques | | |
|---|---|---|---|
| | Grit Blast | Grit Blast | Laser |
| Properties | 24 Mesh | 60 Mesh | Processed |
| Sₐ (confocal | 7.4 microns | 4.2 microns | 16.9 microns |
| microscopy) | | | |
| Adhesion | 54.9 MPa | 34.7 MPa | 54.3 MPa |
| strength | (8000 psi) | (5000 psi) | (7900 psi) |

The adhesion strength of the coating is similar or better when using a laser surface morphology modification as compared to using the known grit blasting technology.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1. A method of coating a surface of a substrate with a thermal spray coating material, the method comprising:
determining an area of the surface of the substrate to be covered with the particulate coating material;
subjecting at least a portion of the area of the surface of the substrate to laser irradiation to form a plurality of distinct spaced-apart laser impact craters in a pattern on the surface of the substrate; and
thermally spraying the area of the surface of the substrate with the thermal spray coating material.

2. The method of claim 1, wherein the surface of the substrate defines a baseline, and wherein each of the distinct laser impact craters has a floor, the floor being below the baseline.

3. The method of claim 2, wherein each of the distinct laser impact craters has a rim, the rim being above the baseline.

4. The method of claim 3, wherein particles of the particulate coating material have a pre-determined pre-impact average diameter; and wherein each of the distinct laser impact craters has a width, the widths being within a range of 50% to 150% of the average particle diameter.

5. The method of claim 4, wherein rims of adjacent distinct laser impact craters are spaced apart by an inter-rim distance, the inter-rim distances being within a predetermined range of the pre-impact average particle diameter.

6. The method of claim 5, wherein each of the distinct laser impact craters has a depth, the depths being within a predetermined range of the pre-impact average particle diameter.

7. The method of claim 1, wherein the pattern is random.

8. The method of claim 1, wherein the pattern is a fixed repeating pattern of aligned rows of laser impact craters forming an aligned array.

9. The method of claim 1, wherein the pattern is a fixed repeating patterns of offset rows of laser impact craters forming a staggered array.

10. A method of coating a surface of a substrate with a thermal spray coating material, the method comprising:
determining an area of the surface of the substrate to be covered with the coating material;
subjecting at least a portion of the area of the surface of the substrate to laser irradiation to form at least one laser impact pit on the surface of the substrate; and
thermally spraying the area of the surface of the substrate with the thermal spray coating material.

11. The method of claim 10, wherein the at least one laser impact pit is a plurality of distinct laser impact pits.

12. The method of claim 11, wherein the surface of the substrate defines a baseline, and wherein each of the plurality of distinct laser impact pit has a floor, the floor being below the baseline.

13. The method of claim 12, wherein each of the distinct laser impact pit has a rim, the rim being above the baseline.

14. The method of claim 13, wherein particles of the thermal spray coating material have an pre-impact average particle diameter; and wherein each of the plurality of distinct laser impact pit has a width, the widths being within a predetermined range of the average pre-impact particle diameter.

15. The method of claim 14, wherein rims of adjacent distinct laser impact pits are spaced apart by an inter-rim distance, the inter-rim distances being within a predetermined range of the average pre-impact particle diameter.

16. The method of claim 15, wherein each of the distinct laser impact pits has a depth, the depths being within a predetermined range of the average pre-impact particle diameter.

17. The method of claim 11, wherein the plurality of distinct laser impact pits form a crisscross pattern.

18. A coated substrate comprising:
a substrate having a plurality of distinct spaced-apart laser impact craters in a pattern on an area of a surface of the substrate;
a thermally-sprayed coating mechanically bonded to at least the area of the surface of the substrate.

19. The coated substrate of claim 18, wherein the surface of the substrate defines a baseline, and wherein each of the distinct laser impact craters has a floor, the floor being below the baseline.

20. The coated substrate of claim 19, wherein each of the distinct laser impact craters has a rim, the rim being above the baseline.

21. The coated substrate of claim 20, wherein each of the distinct laser impact craters has a width and a depth; and rims of adjacent distinct laser impact craters are spaced apart by an inter-rim distance; and the crater widths, crater depths, and inter-rim distances are all within a predetermined range of one another.

22. The coated substrate of claim 18, wherein the pattern is random.

23. The coated substrate of claim 18, wherein the pattern is a fixed repeating pattern of aligned rows of laser impact craters forming an aligned array.

24. The coated substrate of claim 18, wherein the pattern is a fixed repeating pattern of offset rows of laser impact craters forming a staggered array.

25. A coated substrate comprising:
a substrate having at least one laser impact pit on an area of a surface of the substrate;
a thermally-sprayed coating mechanically bonded to at least the area of the surface of the substrate.

26. The coated substrate of claim 25, wherein the at least one laser impact pit is a plurality of distinct laser impact pits.

27. The coated substrate of claim 26, wherein the surface of the substrate defines a baseline, and wherein each of the plurality of distinct laser impact pits has a floor, the floor of each pit being below the baseline.

28. The coated substrate of claim 26, wherein each of the distinct laser impact pits has a width and a depth; and rims of adjacent distinct laser impact pits are spaced apart by an inter-rim distance; and the pit widths, pit depths, and inter-rim distances are all within a predetermined range of one another.

29. The coated substrate of claim 26, wherein the plurality of distinct laser impact pits form a crisscross pattern.
